(19) United States
(12) Patent Application Publication
(10) Pub. No.: US 2026/0359007 A1
(43) Pub. Date: Nov. 12, 2026

(54) METHODS AND APPARATUSES FOR A HIERARCHICAL MULTIPLY-ACCUMULATE CIRCUIT

(71) Applicant: Taiwan Semiconductor Manufacturing Company, Ltd., Hsin-Chu (TW)

(72) Inventors: Win-San Khwa, Taipei City (TW); Che-Kai Liu, Hsinchu City (TW); Ashwin Sanjay Lele, San Jose, CA (US); Bo Zhang, San Jose, CA (US); Xiaoyu Sun, San Jose, CA (US); Meng-Fan Chang, Taichung City (TW)

(21) Appl. No.: 19/341,364

(22) Filed: Sep. 26, 2025

Related U.S. Application Data
(60) Provisional application No. 63/804,280, filed on May 12, 2025.

(51) Int. Cl. G06F 7/50; G06F 7/523

(52) U.S. Cl. CPC G06F 7/50; G06F 7/523

(57) ABSTRACT

Embodiments described herein provide systems, apparatuses and methods for a hierarchical multiply-accumulate (MAC) circuit to perform a MAC operation on a first set of inputs and a second set of inputs. The MAC circuit may include configurable output blocks of multiplexers and output registers placed on every other data path across different stages of the hierarchical MAC architecture to improve output flexibility and enable output register re-use. Additionally, bypass lines may be added between stages of adder circuit to bypass unnecessary addition operations to avoid input toggling and therefore improves power efficiency of the MAC circuit.

### PRIORITY DATA

This application claims priority to U.S. Provisional Patent Application No. 63/804,280 filed on May 12, 2025, the entire disclosure of which is incorporated herein by reference.

### BACKGROUND

Artificial intelligence (AI) systems are often built on neural network models. A neural network often comprises layers of neurons, including an input layer, one or more hidden layers, and an output layer. Input data may then pass through the layers of transformation to generate a predicted output. Specifically, at each layer of the neural network, each connection between neurons is associated with a weight that is a learnable parameter representing the strength of the respective connection. Each neuron may also be associated with an activation function such that the output of the respective neuron is a weighted sum of inputs applied by the activation function. Therefore, at each neuron in each layer of a neural network, a multiply-accumulate (MAC) operation is a fundamental arithmetic computation involving the multiplication of two values (e.g., weights and activations) followed by their accumulation (addition) to an output sum.

MAC units directly execute the dot products that form the basis of neural network inference and training, especially in matrix multiplications found in fully connected and convolutional layers. Due to the massive number of MAC operations required in deep learning, specialized MAC accelerators are designed to improve computational efficiency and throughput.

However, existing hardware implementations of MAC units often face challenges. For one thing, existing MAC accelerators are often sized to handle the largest expected neural network layer (e.g., with largest dimension) within hardware constraints. When processing smaller layers of smaller dimensions, this hardware structure results in underutilization of compute and memory resources—such as only part of the hardware circuits being utilize to perform computations at a smaller dimension—leading to inefficiency. For another, the input counts to be summed together in a MAC operation may sometimes vary when partial sums are added from sliced matrix multiplications. These variable input counts leave parts of the MAC circuit idle, yet these idle paths still remain active to consume switching power, resulting in wasted energy and reduced power efficiency.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1 illustrates an example of neural network model of a computational structure to transform input data into output data, according to one or more embodiments described herein.

FIGS. 2A-2C provide simplified diagrams illustrating examples of a traditional hierarchical MAC architecture, according to one or more embodiments described herein.

FIG. 3 is a simplified diagram illustrating an example partial view of a global MAC adder tree using configurable outputs, according to embodiments described herein

FIG. 4 is a simplified diagram illustrating an example detailed view of the hierarchical structure of a MAC accelerator including the global MAC adder tree using configurable outputs shown in FIG. 3, according to embodiments described herein.

FIG. 5 is a simplified diagram illustrating an example partial view of a hierarchical structure of a MAC accelerator using AND gates to avoid input toggle and multiplexers for bypass, according to embodiments described herein.

FIG. 6 is a simplified diagram illustrating an example detailed view of a hierarchical structure of a MAC accelerator comprising the partial structure shown in FIG. 5, according to embodiments described herein.

FIG. 7 is a simplified diagram illustrating an example detailed view of a hierarchical structure of a MAC accelerator combining the MAC structure shown in FIGS. 4 and 6, according to embodiments described herein.

FIG. 8 is a simplified diagram illustrating another example embodiment of a hierarchical structure of a MAC accelerator combining the MAC structure shown in FIGS. 4 and 6, according to embodiments described herein.

FIGS. 9A-9B provide example logic flow charts illustrating process for operating a MAC accelerator having a hierarchical architecture described in FIGS. 3-8, according to embodiments described herein.

FIG. 10 is a simplified diagram illustrating a computing device implementing a neural network on an AI accelerator comprising the circuit structures described in FIGS. 3-8, according to one embodiment described herein.

### DETAILED DESCRIPTION

The following disclosure provides many different embodiments, or examples, for implementing different features of the invention. Specific examples of components and arrangements are described below to simplify the present disclosure. These are, of course, merely examples and are not intended to be limiting. For example, the formation of a first feature over or on a second feature in the description that follows may include embodiments in which the first and second features are formed in direct contact and may also include embodiments in which additional features may be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed.

Further, spatially relative terms, such as “beneath,” “below,” “lower,” “above,” “upper” and the like, may be used herein for ease of description to describe one element or feature’s relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly.

As used herein, the term “network” may comprise any hardware or software-based framework that includes any artificial intelligence network or system, neural network or system and/or any training or learning models implemented thereon or therewith.

As used herein, the term “module” may comprise hardware or software-based framework that performs one or more functions. In some embodiments, the module may be implemented on one or more neural networks.

In recent years, the rapid advancements in artificial intelligence (AI) and machine learning have significantly impacted various industries, from healthcare and finance to automotive and consumer electronics. As AI systems become increasingly sophisticated, their computational demands have escalated, driving the need for more efficient and powerful processing solutions. AI accelerators such as graphics processing units (GPUs) and tensor processing units (TPUs) have been adopted to implement neural network models that usually entail a large amount of matrix operations, including MAC operations.

The instant application relates to computational circuits, and more specifically to methods and apparatuses for a hierarchical MAC circuit with improved output flexibility and power efficiency. Specifically, embodiment described herein provide an arithmetic logic unit (ALU) circuit for performing a MAC operation on two input vectors or matrices. The circuit may comprise a plurality of multiplication circuits configured to multiply the first set of inputs and the second set of inputs, and an adder tree including one or more levels of adder circuits to sum products from the plurality of multiplication circuits. In one embodiment, the adder tree may further include configurable output blocks of multiplexers and output registers across different stages. For example, the output register is configured to store an output from a first adder circuit, and the multiplexer is configured to selectively transmit the output from the first adder circuit or a logic value of zero to a second adder circuit at the next level. In this way, when half or more inputs are zero due to a smaller computational dimension (e.g., smaller neural network layers), the MAC operation may be performed efficiently by sampling the final output from an output register of an actively used adder circuit and thus unused adder circuits at higher levels may be refrained from further processing. The multiplexers and output ports are added on every-other path across the adder tree to enable output register re-use.

In another embodiment, the ALU circuit may employ an AND gate and a bypass line directly connecting a first multiplication circuit of the plurality of multiplication circuit and a first multiplexer placed at an output of a first adder circuit to bypass unnecessary additions. For example, an AND gate is placed between the first multiplication circuit and the first adder circuit and configured to selectively transmit a multiplication output from the first multiplication circuit or a logic value of zero after an AND operation with zero to the first adder circuit. The AND gate is turned on by a configuration signal when at least one input to the first multiplication circuit is zero so as to pass a zero to the first adder circuit after an AND operation with zero. A multiplexer placed after the first adder circuit has three inputs of the first bypass line, the first output form the first adder circuit, and a second bypass line directly connected to a second multiplication circuit. The first multiplexer is configured to output from the first bypass line when at least one input to the second multiplication circuit is zero. The first adder circuit is thus bypassed without further processing. In this way, the bypass ability may prevent unnecessary switching energy at the adder tree.

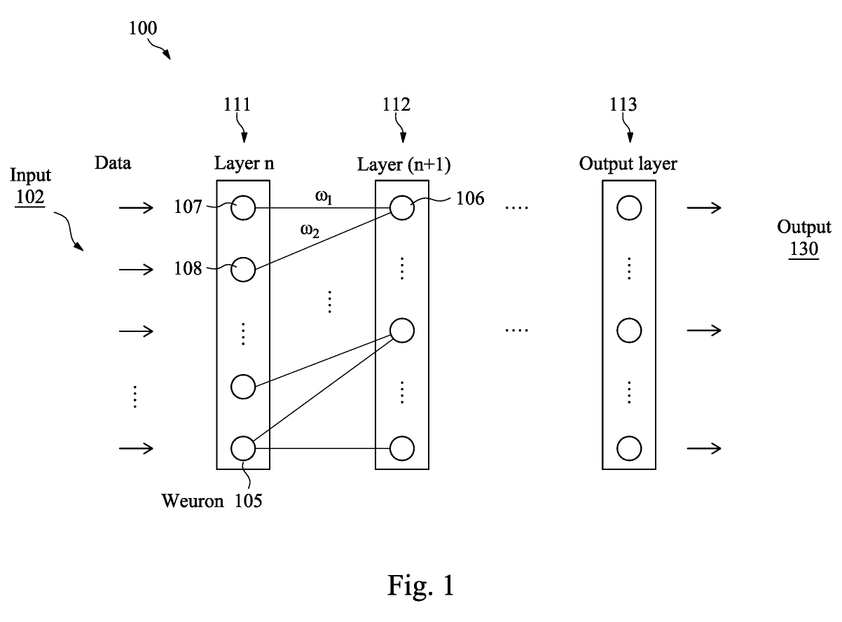

FIG. 1 illustrates an example of neural network model 100 of a computational structure to transform input data 102 into output data 130, according to one or more embodiments described herein. For example, the neural network model 100 may be a language model that transforms input data 102 of a sequence of tokens representing a natural language question into an output sequence of tokens 130 representing an answer to the natural language question. For another example, the neural network model 100 may be an image classification model that transforms input data 102 representing image data of an input image into an output classification result 130 indicating what object the input image contains, e.g., orange or lemon, dog or cat, etc.

In one embodiment, the neural network model 100 may comprise a structure of a collection of connected units or nodes, referred to as neurons 105. Neurons 105 are often connected by edges, and an adjustable weight is often associated with the edge. The neurons are often aggregated into a plurality of layers 111-113 such that different layers 111-113 may perform different transformations on the respective input and output transformed input data onto the next layer.

For example, an input layer 111 receives the input data 102 as each neuron receives input signals, performs a weighted sum of the inputs according to weights assigned to each connection, and then applies an activation function associated with the respective neuron to the result. The output of the activation function is passed to the next layer 112 of neurons (e.g., 106 at layer 112). The activation function may be the same or different across different layers. Example activation functions include but not limited to Sigmoid, hyperbolic tangent, Rectified Linear Unit (ReLU), Leaky ReLU, Softmax, SiLU, and/or the like. In this way, after a number of layers, input data 102 received at the input layer is transformed into rather different values indicative data characteristics corresponding to a task that the neural network structure has been designed to perform.

For example, the neuron 106 of layer 112 may receive a weighted sum of inputs from neurons 107 and 108 in layer 111, each weighted (multiplied) by w 1 and w 2, and an activation function associated with neuron 106 may be applied to the weighted sum to generate an output from the neuron 106. Therefore, to obtain the weighted sum as an input to the neuron 106, the MAC operation may be performed at each neuron in the neural network model 100.

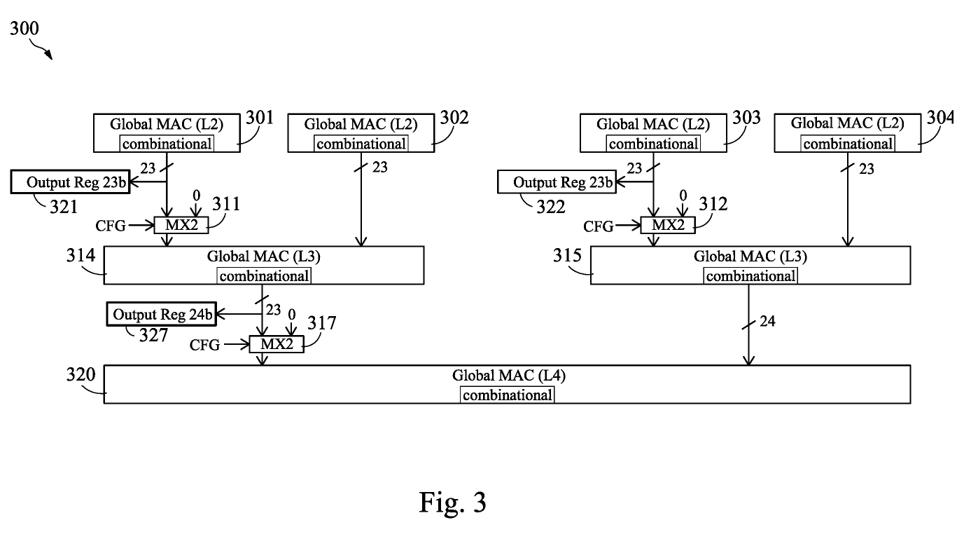

In one embodiment, the neural network model 100 may be implemented at a hardware-based accelerator circuit, such as an application specific integrated circuit (ASIC). The accelerator circuit may comprise a plurality of MAC units to perform the MAC operation for the numerous neurons. Detailed architecture of such MAC units may be described in relation to FIGS. 3-8.

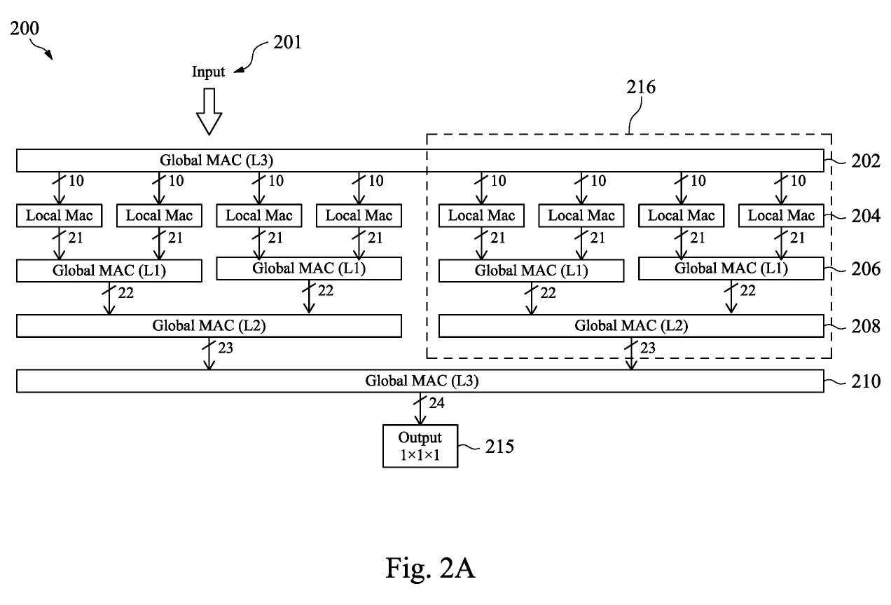

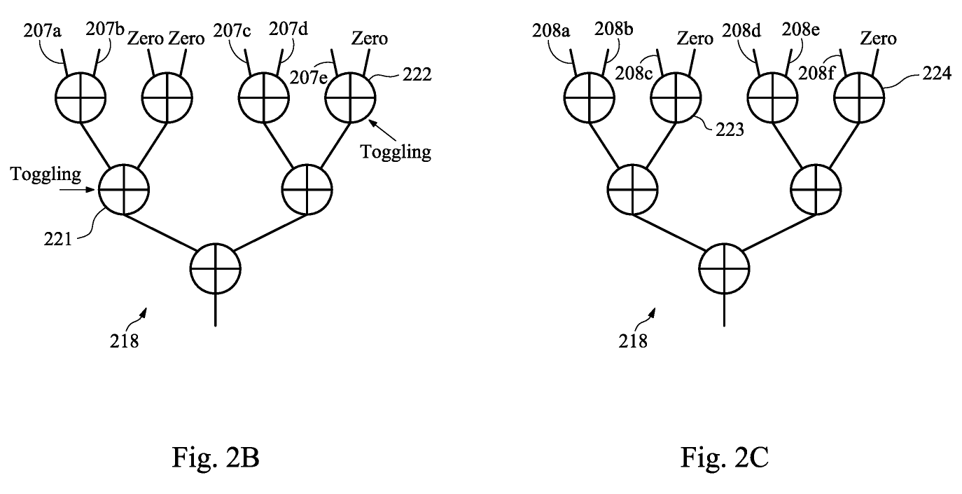

FIGS. 2A-2C provide simplified diagrams illustrating examples of a traditional hierarchical MAC architecture, according to one or more embodiments described herein. In FIG. 2A, circuit diagram 200 may illustrate a hierarchical architecture of a MAC accelerator, to perform MAC-involved operations, such as convolution, and/or the like on the input data 201 to generate an output 215. The MAC accelerator may comprise a reusable and/or pre-designed memory block such as a Magnetoresistive Random Access Memory (MRAM) 202, a plurality of local MACs 204 performing MAC operations locally at each segment of the input data, different levels of global MACs 206, 208 and 210 to accumulate partial sums from multiple MAC units from the upper level.

For example, each local MAC 204 may receive two inputs Ai and Bi and perform a local product Ai ×Bi. The product from each local MAC 204 may be then fed to multiple stages 206, 208 and 10 of global MAC adder tree to sum all the product outputs from the local MAC units 204. For instance, the global MAC adder tree works in log(N) (N is the number of local MAC units 204) depth using pairwise additions across multiple stages, e.g., at stage 1: adds 2 products at a time; at stage 2: adds the sums from stage 1, and so on. Eventually, the level 3 global MAC 210 outputs the final output 215.

It is worth noting that the 8 local MAC units and 3 levels of global MAC shown in FIG. 2 is for illustrative purpose only. Any different number N of local MAC units may be employed, and (logN) levels of global MAC may be used.

The MAC accelerator may be designed to support the largest affordable neural network layer (largest number of neurons per layer) under hardware constraints. For example, the MAC accelerator may be applied to a convolutional layer having a 1×1 convolutional kernel, and 32 output channels -- input data 201 may have a dimension of 32.

However, at a smaller layer with only 16 output channels (neurons), only half of the MAC accelerator may be utilized, leaving the other half 216 of MAC units idling. Compute and memory utilization is inefficient in this situation.

FIGS. 2B-2C show an adder tree 218 (e.g., global MAC adder tree) comprised in the hierarchical MAC architecture shown in FIG. 2A. The adder tree 218 may add partial sums (e.g., from MAC units from the upper level). For example, in neural networks (e.g., convolutional neural networks, Transformer networks, etc.) where large matrix multiplications of variables are often involves at layers, such large matrix may be too large to fit in on-chip memory or compute units. Instead of processing the entire matrices at once, large matrices are sliced along one or more dimensions (rows, columns, or depth) to allow efficient use of limited memory or compute units. For example, at a convolution layer where matrix multiplication of a first matrix representing activations and a second matrix representing weights, the first matrix may be sliced into row blocks, and/or the second matrix may be sliced into column blocks. The partial products for each slice may be computed, and then the results are accumulated across slices using the adder tree 218 to get the full output matrix for the convolution layer.

Due to different slicing strategies, the adder tree 218 may often add a varying number of inputs. The number of additions in the global adder tree 218 are often not a power of 2. When the capacity of the adder tree 218 is more than the number of inputs, some adders have one of their inputs as 0 and cause unnecessary toggling (IN + zero = IN). For example, as shown in FIG. 2B, only 5 inputs 207a-e are input to the adder tree 218. In that case, adders 221 and 222 may be idle (not needed for the respective partial sum for adding a non-zero value to zero). However, signals still propagate through adders 221 and 222, causing redundant toggling at the adder, e.g., the switching activity of the digital logic gates inside the adder that causes capacitive charging and discharging, and therefore leads to energy waste. As shown in FIG. 2C, only 6 inputs 208a-f are input to the adder tree 218. In that case, adders 223 and 224 may be idle but toggling, causing energy waste.

FIG. 3 is a simplified diagram illustrating an example partial view of a global MAC adder tree 300 using configurable outputs, according to embodiments described herein. The global MAC adder tree 300 shown in FIG. 3 may comprise stages of global MAC units similar to that in FIG. 2, whereas each MAC unit may receive two inputs, e.g., from the outputs of MAC units in the previous stage, sum the two inputs together, and selectively pass the sum to the next stage global MAC adder via a multiplexer selection.

For example, each of the level 1 MAC units 301, 302, 303 and 304 may receive two inputs from a stage of local MAC units (204 shown in FIG. 2) and perform a MAC operation on the two inputs to generate a respective MAC output. Each of the level 2 MAC units 314 and 315 may receive two inputs from the stage of level 1 MAC units 301, 302, 303, 304, respectively and similarly perform a MAC operation, and so on.

In one embodiment, a multiplexer and a register may be placed between two levels of global MAC units to selectively configure the output from a global MAC of a previous level to a global MAC at the next level, e.g., multiplexer 311 and register 321 between global MAC 301 and global MAC 314, multiplexer 312 and register 322 between global MAC 303 and global MAC 315, multiplexer 317 and register 327 between global MAC 304 and global MAC 320, and/or the like. In this way, each global MAC unit (except the final global MAC unit 320) may be either connected to a multiplexer, or connected to the next level of global MAC; and the multiplexer and register is placed in every other data path across different stage of the global MAC adder tree to allow sampling of outputs from any of them.

In one embodiment, each multiplexer 311, 312 or 318 is configured by a selection signal CFG to selectively output one of its two input signals, e.g., 0 or the partial sum output from the previous stage of global MAC unit. For example, when CFG for the multiplexer 311 is configured, e.g., by a microcontroller or central processing unit (CPU), with a first value (e.g., a logic value of 0), the multiplexer 311 may transmit the output from the global MAC unit 301 to the next stage global MAC unit 314, and the output is stored at the output register 321. On the other hand, when the CFG is configured with an opposite value, the multiplexer 311 may transmit 0 to the next stage global MAC unit 314 – in this case, the output register 321 may still output a value but will not be selected by the multiplexer 314. Similarly, multiplexers 312 and 317 may operate in a similar manner. In other words, a microcontroller and/or CPU may configure the CFGs for the multiplexers between stages of global MAC units to selectively sample outputs from the previous stage to pass onto the next stage.

In this way, the configurable output selections across different stages of the global adder tree allow the smaller layers to be computed efficiently. For example, when a path is not used (with an input of zero because of smaller input matrix or vector size), one or more CFGs on this path may be correspondingly configured such that the multiplexer will output zero to the next stage global MAC unit.

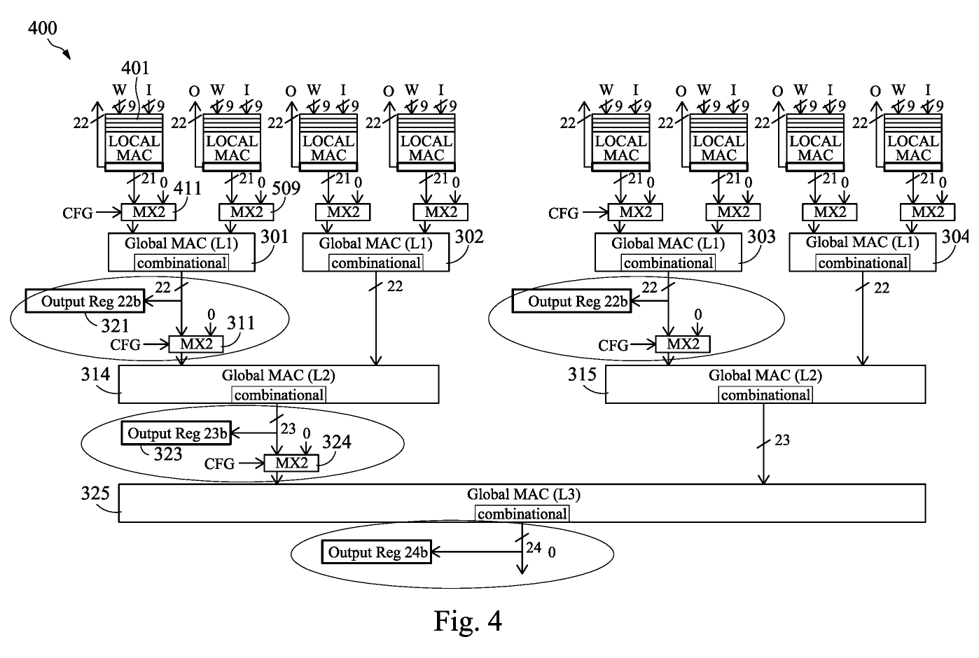

Additionally, instead of placing a multiplexer and output register at the output of every global MAC unit, the multiplexers and output registers are placed on every other path between stages across the global adder tree 300 to enable output register re-use, as described in further detail below in FIG. 4.

FIG. 4 is a simplified diagram illustrating an example detailed view of the hierarchical structure 400 of a MAC accelerator including the global MAC adder tree 300 using configurable outputs shown in FIG. 3, according to embodiments described herein. The hierarchical structure 400 may comprise multiple (e.g., 8) local MAC units, each configured to perform multiplication of two inputs (e.g., 9 bits) and generate a product at 21 bits. In addition to the configuration output circuit of a multiplexer and an output register between two stages of global MAC units as shown in the adder tree 300, a multiplexer 411 may be placed between each local MAC unit (e.g., 401) and the respective level 1 global MAC unit (e.g., 301). The multiplexer 411 is configured by a selection signal CFG to selectively output the product from the local MAC unit 401 for next level summation or a logic value of 0. In the meantime, when a logic value of 0 is passed to the next level MAC unit, output of the MAC accelerator may be sampled from the respective output register.

For example, in a similar scenario as described in FIG. 2A, when only the left half of the circuit structure 400 is used to process computations for a smaller input dimension (e.g., smaller neural network layer), global MAC units 303, 304, 315 on the right half may be idle. In that case, the microcontroller and/or CPU may decide, for each multiplexer, the CFT depending on whether the next level global MAC connected to the respective multiplexer need to function or idle. For instance, the multiplexer 411 may be configured by CFG to transmit the product of local MAC unit 401 to the level 1 global MAC unit 301 because level 1 summation is performed at the level 1 global MAC unit 301. Similarly, the multiplexer 311 may be configured by CFG to transmit the result from the level 1 global MAC unit 301 to the level 2 global MAC unit 314 because level 2 summation is performed at the level 2 global MAC unit 314. However, the multiplexer 324 may be configured by CFG to transmit a logic value of 0 to the level 3 global MAC unit 325, because the right half global MAC unit 315 is idling and the final output is the same as the output from the level 2 global MAC unit 314. Thus, the final output of the hierarchical architecture 400 may be sampled from the output register 323. In this way, the right half of the circuit and the level 3 global MAC unit 325 do not need to process at all to save energy.

Therefore, the multiplexers in the hierarchical structure 400 of a MAC accelerator collectively allow a microcontroller or a CPU to sample outputs along different input-output path across different stages within the hierarchical structure 400. By using multiplexers to disable the input to the next level global MAC unit (adder circuit), unused inputs or paths can be masked when fewer elements are being processed, e.g., due to fewer input elements from a smaller layer (scenario described in FIG. 2A). In addition, because output registers are placed on every-other path between stages across the hierarchical structure 400, outputs along different input-output path across different stages may be sampled, without having to place an output register at every global MAC unit for output sampling. In this way, the hardware and power efficiency of the MAC accelerator is improved.

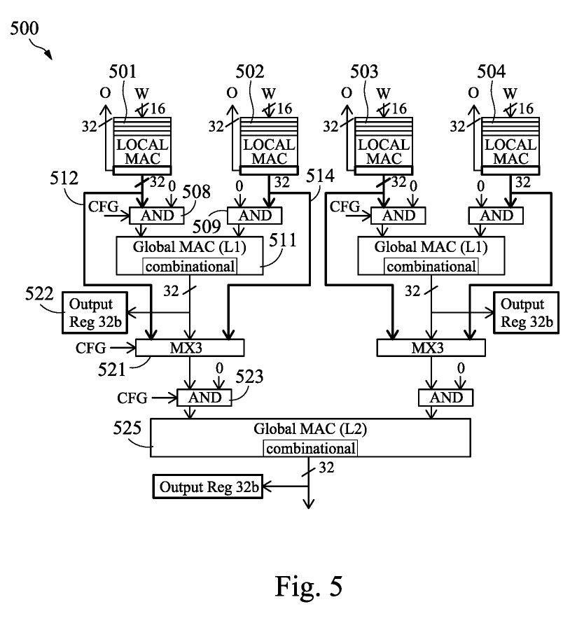

FIG. 5 is a simplified diagram illustrating an example partial view of a hierarchical structure 500 of a MAC accelerator using AND gates to avoid input toggle and multiplexers for bypass, according to embodiments described herein. The hierarchical structure 500 shows 4 local MAC units 501-504, each connected to an AND logic gate between the respective logical MAC unit and a next level global MAC unit. For example, the AND gate 508 is placed between the local MAC unit 501 and the level 1 global MAC unit 511, and the AND gate 509 is placed between the local MAC unit 502 and the level 1 global MAC unit 511, and so on. Each AND gate 508 or 509 is controlled by a configuration signal CFG to either turn on and off, e.g., to pass on the product output from the local MAC unit 501 or 502 to the level 1 global MAC unit 511 when the AND gate is off; or to pass on a logic value of 0 after AND 0 to the level 1 global MAC unit 511 when the AND gate is on.

Additionally, the level 1 global MAC unit 511 is connected to a multiplexer 521 at its output. The multiplexer 521 is configured by a selection signal CFG to output one of three inputs: a first input from a bypass line 512 directly passing on the product output from the local MAC unit 501, a second input from a bypass line 514 directly passing on the product output from the local MAC unit 502, and a third input from the (partial) summation output from the level 1 global MAC unit 511.

For example, if one of the inputs to the local MAC unit 501 is 0, the CFG for the AND gate 508 may be configured to a first logic value (e.g., 1) such that the AND gate 508 is turned on to output 0 after the AND 0 to the global MAC unit 511. In this case, the multiplexer 521 is configured to select the input from the bypass line 514, because the global MAC unit 511 only receives 0 from the local MAC unit 501 and has no need to perform an addition. Thus, global MAC unit 511 can be bypassed. Similarly, if at least one of the inputs to local MAC unit 502 is 0, the multiplexer 521 is configured to select the input from the bypass line 512 such that the global MAC unit 511 can be similarly bypassed.

In one embodiment, each global MAC unit in the hierarchical structure 500 may be paired with an output register at the respective output such that the output may be sampled from the output register.

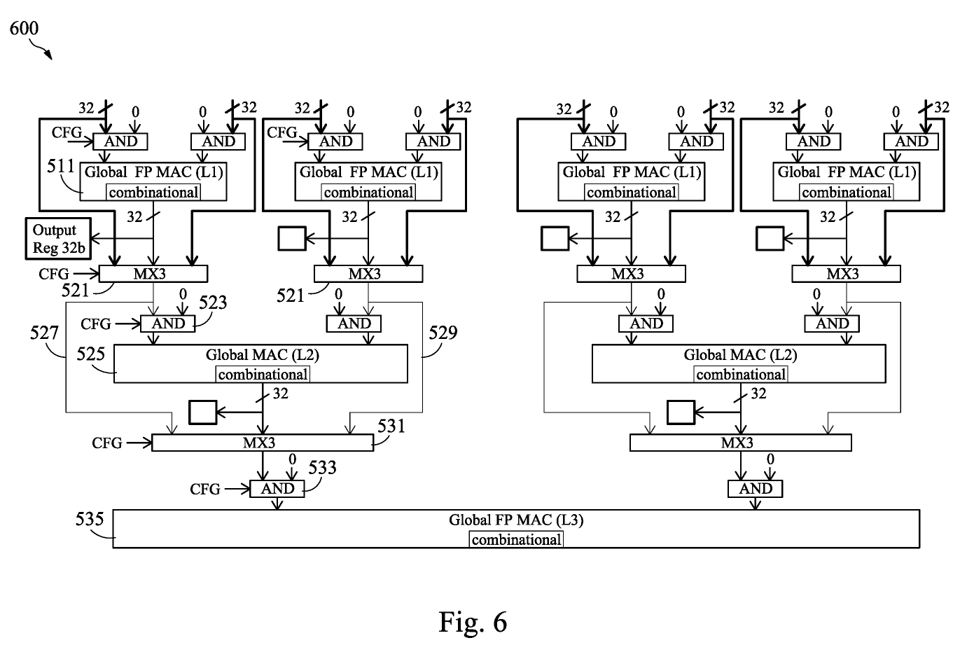

In one embodiment, the multiplexer 521 may be further coupled to another AND gate 523 connected to the next level, e.g., level 2 global MAC unit 525. The AND gate 523 may be controlled by a configuration signal CFG in a similar manner. For example, if each local MAC unit 501 and 502 has at least one zero input, meaning the outputs of the two local MAC 501 and 503 are both 0, additional details of further bypassing are shown in FIG. 6.

FIG. 6 is a simplified diagram illustrating an example detailed view of a hierarchical structure 600 of a MAC accelerator comprising the partial structure 500 shown in FIG. 5, according to embodiments described herein. Continuing on from the multiplexer 521 shown in FIG. 6 (and similarly shown in FIG. 5), the output of the multiplexer 521 may be connected to the bypass line 527 to the next stage multiplexer 531.

For example, if each local MAC unit 501 and 502 (shown in FIG. 5) has at least one zero input, meaning the output of the level 1 global MAC unit 511 will be 0, the output of multiplexer 521 or AND gate 523 will always be 0 anyway. In that case, the level 2 global MAC unit 525 may be further bypassed because no addition is necessary – the multiplexer 531 connected to the level 2 global MAC unit 525 may be configured by the respective CFG to select the output from the bypass line 529 as output, because only the output from bypass line 527 would be 0 anyway. In that case, the level 2 global MAC unit 525 (in addition to level 1 global MAC unit that is bypassed as discussed in FIG. 5) is further bypassed to avoid adder circuit toggling so as to save energy.

Therefore, the multiplexers, AND gates and bypass lines in the hierarchical structure 600 of a MAC accelerator allows certain global MAC units in the global MAC adder tree to be bypassed, e.g., not having signals propagating through, in a similar scenario as described in FIG. 2B and 2C. Unnecessary switching activities in the adder tree can thus be reduced. In this way, the hardware and power efficiency of the MAC accelerator is improved.

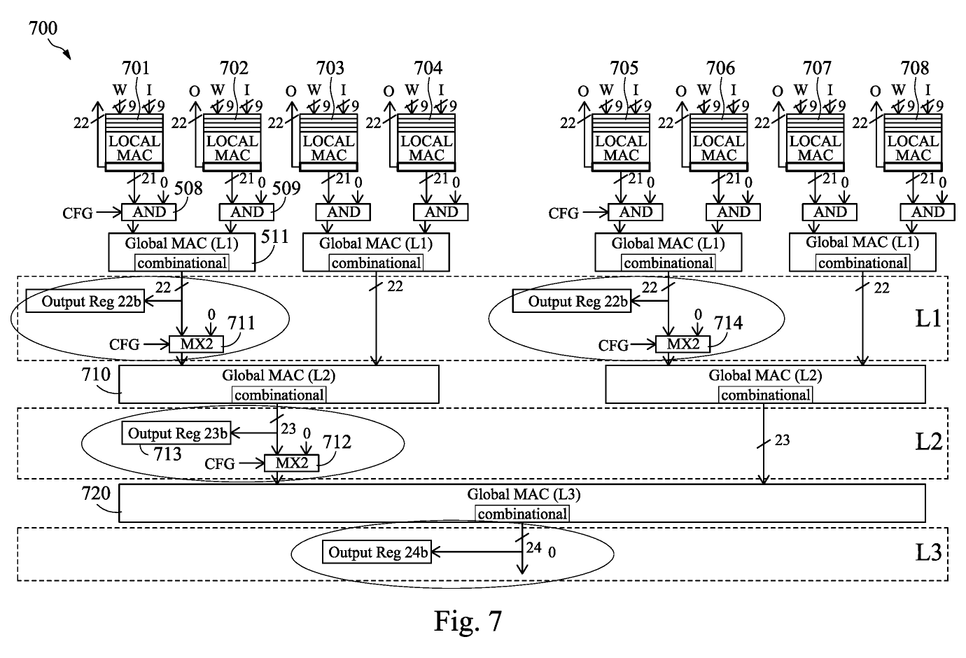

FIG. 7 is a simplified diagram illustrating an example detailed view of a hierarchical structure 700 of a MAC accelerator combining the MAC structure shown in FIGS. 4 and 6, according to embodiments described herein. In the hierarchical structure 700, each of L1/L2/L3 may represent a layer of computation. For example, a 21 bits data is transmitted to global MAC (L1) 511 and generate a 22 bits data in layer L1. The 22 bits data in layer L1 is transmitted to global MAC (L2) 710 and generates a 23 bits data in layer L2. The 23 bits data in layer L3 is transmitted to global MAC (L3) 720 and generate a 24 bits data in layer L3.

In one embodiment, AND gates such as 508, 509 are placed between the local MAC units and the level 1 global units similar to those in FIGS. 5-6, and a multiplexer and output register structure are put at every other path at each stage of global MAC unit to sample outputs across stages of the adder tree similar to those in FIGS. 3-4.

For example, in a similar scenario as described in FIG. 2A, when only the left half (local MAC units 701-704) of the circuit structure 700 is used to process computations for a smaller input dimension (e.g., smaller neural network layer), the right half (local MAC units 705-708) of the circuit structure 700 may be idling. Similar to that explained in relation to FIG. 4, the final output of the MAC accelerator may be sampled at the output register 713 after the level 2 global MAC on the left side. Stage L3 is not processed at all, and the right half of stage L1 and L2 is not processed.

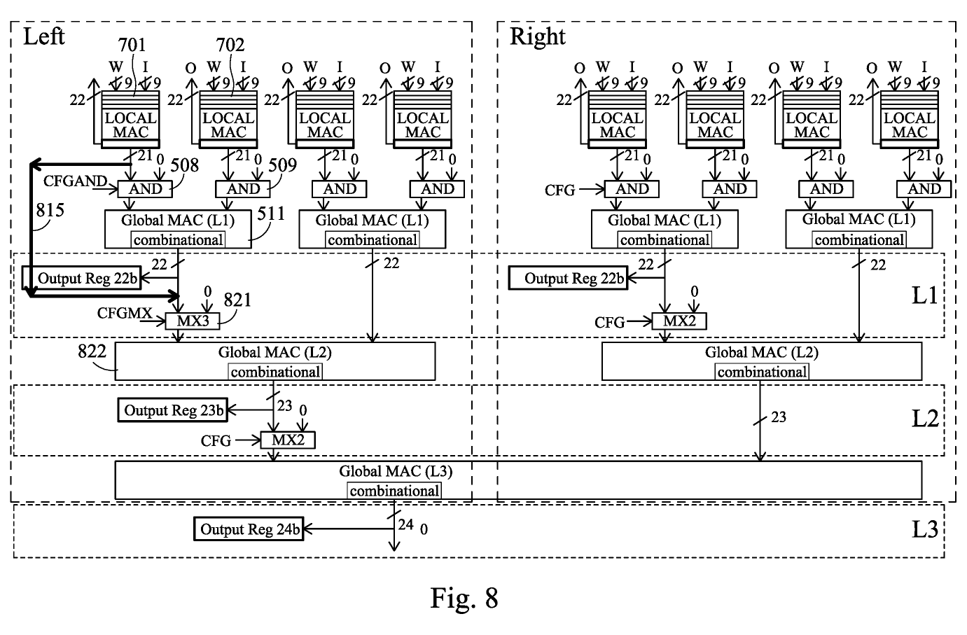

FIG. 8 is a simplified diagram illustrating another example embodiment of a hierarchical structure 800 of a MAC accelerator combining the MAC structure shown in FIGS. 4 and 6, according to embodiments described herein. Instead of using 2:1 multiplexers throughout the hierarchical structure 700, the hierarchical structure 800 may employ a 3:1 multiplexer 821 similar to 521 in FIG. 5. A bypass line 815 may connect the output of the local MAC unit 701 to the multiplexer 821. In that case, the multiplexer 831 may be configured by the selection signal CFGMX to selectively output one of its three inputs: a first input from the bypass line 815, the output of level 1 global MAC unit 511, and a logic value of 0.

For example, in scenarios similar to those described in FIGS. 2B-2C, when an input to local MAC unit 702 is 0, meaning the output from the local MAC unit 702 to the level 1 global MAC unit 511 would be 0 anyway, the multiplexer 821 may be configured to select the output from the local MAC unit 701 following bypass line 815 to bypass the level 1 global MAC unit 511. In this way, the multiplexer 821 may bypass the output data from the local MAC unit 702 to the level 2 global MAC unit 822 without wasting power at level 1 global MAC unit 511.

It is to be noted that the circuit structures shown in FIGS. 7 and 8 to combining the MAC structure shown in FIGS. 4 and 6 are for illustrative purpose only. In various embodiments, 3:1 multiplexers may be added at different stages of the global MAC adder tree to bypass a global MAC unit at a respective stage. In various embodiments, the AND gate may be added at different stages of the global MAC adder tree to force a zero input to the next stage global MAC unit. In various embodiments, output registers and a 2:1 multiplexer may be added at different stages of the global MAC adder tree, e.g., at every other data path, to sample an output at the respective stage as the final output of the MAC accelerator.

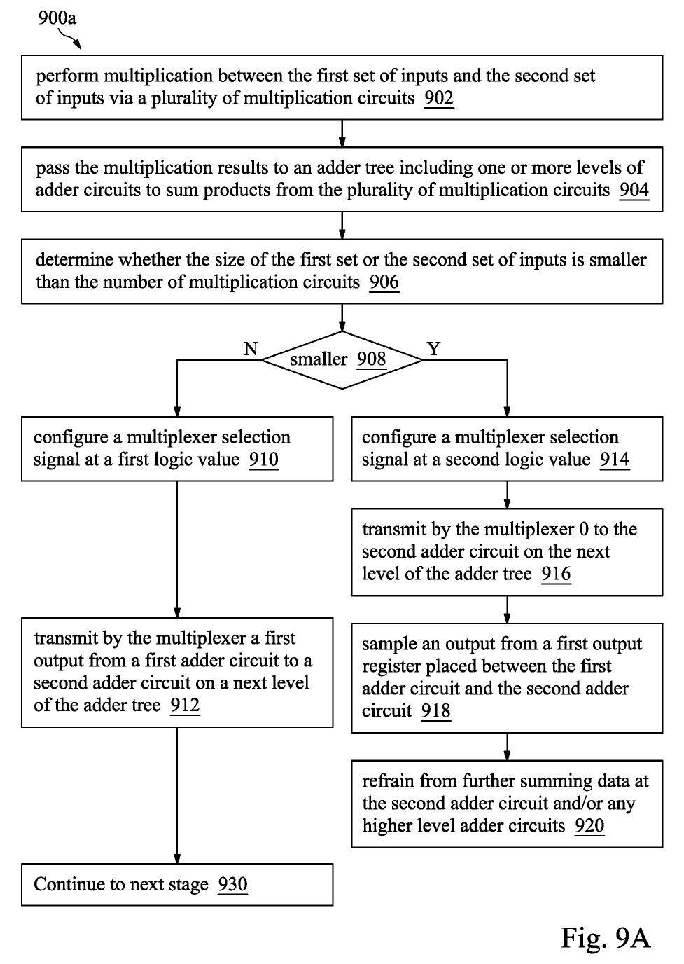

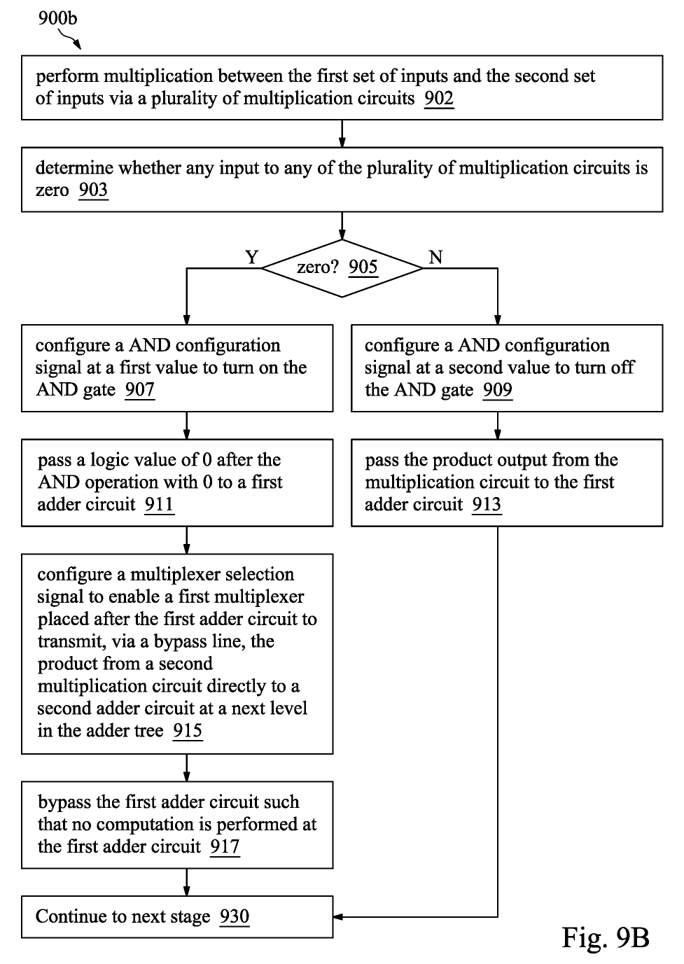

FIGS. 9A-9B provide an example of logic flow charts illustrating process 900a-b for operating a MAC accelerator having a hierarchical architecture described in FIGS. 3-8, according to embodiments described herein. One or more of the processes of methods 900a-b may be implemented, at least in part, in the form of executable code stored on non-transitory, tangible, machine-readable media that when run by one or more processors may cause the one or more processors to perform one or more of the processes. In some embodiments, methods 900a-b correspond to a method of performing a multiply-accumulation operation on a first set of inputs and a second set of inputs using the hierarchical architecture shown in FIGS. 3-8.

As illustrated, the methods 900a-b includes a number of enumerated steps, but aspects of the methods 900a-b may include additional steps before, after, and in between the enumerated steps. In some respects, one or more of the enumerated steps may be omitted or performed in a different order.

At step 902, a plurality of multiplication circuits (e.g., 401 in FIG. 4) may perform multiplication between the first set of inputs and the second set of inputs.

At step 904, an adder tree may sum products from the plurality of multiplication circuits. The adder tree includes one or more levels of adder circuits (e.g., 301, 314, 325 in FIG. 4).

At step 906, a processor (e.g., a microcontroller) may determine whether the size of the first set or the second set of inputs is smaller than a number of the plurality of the multiplication circuits (e.g., scenario depicted in FIG. 2A). If the size is not smaller at decision 908, method 900a may proceed to step 910, at which the processor may configure a multiplexer selection signal at a first logic value (e.g., 1) for a first multiplexer (e.g., 324 in FIG. 4) placed between a first adder circuit (e.g., 314 in FIG. 4) and a second adder circuit (e.g., 325 in FIG. 4) on a next level to the adder tree. At step 912, the first multiplexer (e.g., 324 in FIG. 4) may thereby transmit a first output from the first adder circuit to the second adder circuit. Method 900a may further proceed to step 930 to continue to next stage processing at the adder tree.

Alternatively, If the size is not smaller at decision 908, method 900a may proceed to step 914, at which the processor may configure a multiplexer selection signal at a first logic value (e.g.,0) for the first multiplexer (e.g., 324 in FIG. 4). At step 916, the first multiplexer (e.g., 324 in FIG. 4) may thereby transmit zero to the second adder circuit (e.g., 325 in FIG. 4). At step 918, a first output register (e.g., 323 in FIG. 4) storing the first output from the first adder circuit (e.g., 314 in FIG. 4) may be sampled an output for the adder tree. At step 920, method 900a may refrain from further summing data at the second adder circuit (e.g., 325 in FIG. 4) or any higher level adder circuit.

In various embodiments, method 900b shown in FIG. 9B may continue from step 902. If an input is zero (e.g., one of the inputs to multiplication circuit 501 in FIG. 5) at decision 905, method 900b may proceed to step 907, at which the processor may configure an AND configuration signal at a first logic value to turn on an AND gate (e.g., 508 in FIG. 5) placed between a first multiplication circuit (e.g., 501 in FIG. 5) and the first adder circuit (511 in FIG. 5). At step 911, the AND gate may pass a logic value of 0 after the AND operation with 0 to the first adder circuit. At step 915, the processor may configure a multiplexer selection signal to enable a first multiplexer (e.g., 521 in FIG. 5) placed after the first adder circuit (e.g., 511 in FIG. 5) to transmit, via a bypass line (e.g., 514 in FIG. 5), the product from a second multiplication circuit (e.g., 502 in FIG. 5) directly to a second adder circuit (e.g., 525 in FIG. 5) at a next level in the adder tree. At step 917, the first adder circuit (e.g., 511 in FIG. 5) may thus been bypassed such that no computation is performed at the first adder circuit.

Alternatively, if no input is zero at decision 905, method 900b may proceed to step 909, at which the processor may configure an AND configuration signal at a second logic value to turn off an AND gate. At step 913, the AND gate may pass the product output from the multiplication circuit (e.g., 501 in FIG. 5) to the first adder circuit (e.g., 511 in FIG. 5).

From steps 913 or 917, method 900b may then proceed to step 930 to continue to the next stage of the adder tree.

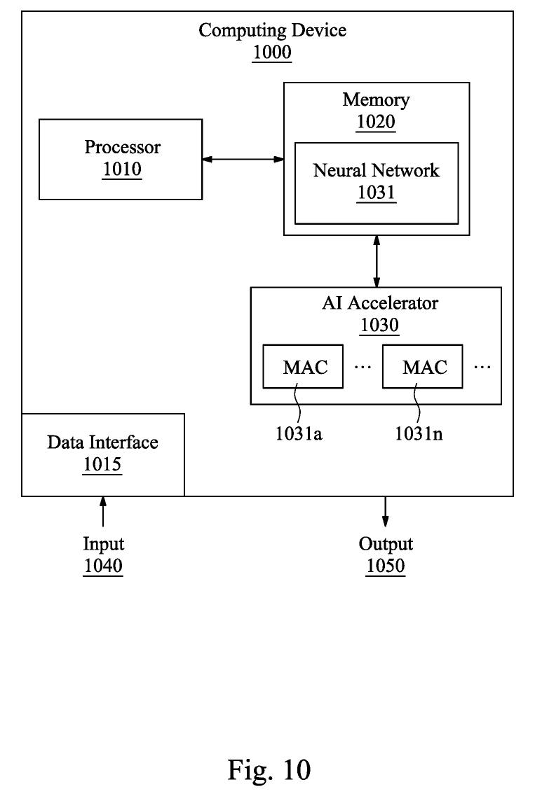

FIG. 10 is a simplified diagram illustrating a computing device implementing a neural network on an AI accelerator comprising the circuit structures described in FIGS. 3-8, according to one embodiment described herein. As shown in FIG. 10, computing device 1000 includes a processor 1010 coupled to memory 1020. Operation of computing device 1000 is controlled by processor 1010. And although computing device 1000 is shown with only one processor 1010, it is understood that processor 1010 may be representative of one or more central processing units, microcontrollers, multi-core processors, microprocessors, microcontrollers, digital signal processors, field programmable gate arrays (FPGAs), application specific integrated circuits (ASICs), graphics processing units (GPUs) and/or the like in computing device 1000. Computing device 1000 may be implemented as a stand-alone subsystem, as a board added to a computing device, and/or as a virtual machine.

Memory 1020 may be used to store software executed by computing device 1000 and/or one or more data structures used during operation of computing device 1000. Memory 1020 may include one or more types of machine-readable media. Some common forms of machine-readable media may include floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, and/or any other medium from which a processor or computer is adapted to read.

Processor 1010 and/or memory 1020 may be arranged in any suitable physical arrangement. In some embodiments, processor 1010 and/or memory 1020 may be implemented on a same board, in a same package (e.g., system-in-package), on a same chip (e.g., system-on-chip), and/or the like. In some embodiments, processor 1010 and/or memory 1020 may include distributed, virtualized, and/or containerized computing resources. Consistent with such embodiments, processor 1010 and/or memory 1020 may be located in one or more data centers and/or cloud computing facilities.

In another embodiment, processor 1010 may comprise multiple microprocessors and/or memory 1020 may comprise multiple registers and/or other memory elements such that processor 1010 and/or memory 1020 may be arranged in the form of a hardware-based neural network, as further described in FIGS. 1-6.

In some examples, memory 1020 may include non-transitory, tangible, machine readable media that includes executable code that when run by one or more processors (e.g., processor 1010) may cause the one or more processors to perform the methods described in further detail herein. For example, as shown, memory 1020 includes instructions for operating a neural network 1031, such as but not limited to a Transformer based network, a convolutional neural network, a feed forward network, and/or the like.

Memory 1002 may further couple to an AI accelerator 1030, which may comprise a plurality of MAC accelerators 1031a-n. Each MAC accelerator may comprise one or more hierarchical architecture as described in FIGS. 3-8.

For example, at least one MAC accelerator 1031a-n may comprise a circuit for performing a multiply-accumulation operation on a first set of inputs and a second set of inputs. The circuit may comprise a plurality of multiplication circuits configured to multiply the first set of inputs and the second set of inputs, an adder tree including one or more levels of adder circuits to sum products from the plurality of multiplication circuits, a first output register and a first multiplexer placed between a first adder circuit and a second adder circuit on a next level of the adder tree. The first output register is configured to store a first output from the first adder circuit, and the first multiplexer is configured to selectively transmit the first output from the first adder circuit or a logic value of zero to the second adder circuit. The circuit may further comprise at least a second multiplexer, placed between one multiplication circuit of the plurality of multiplication circuits and a first level adder circuit in the one or more levels adder circuits, configured to selectively transmit a multiplication output from the one multiplication circuit or a logic value of zero to the first level adder circuit. The adder tree further comprises a respective output register connected to a respective output at each level of adder circuit; and a respective multiplexer placed between each level of adder circuit and a respective next level of adder circuit. Multiple output registers are placed at every other adder circuit at each level of adder circuit for output sampling. The circuit may further comprise an AND gate, placed between a first multiplication circuit and a first adder circuit, configured to selectively transmit a logic value of zero after an AND operation with zero to the first adder circuit when the AND gate is on, or a multiplication output from the multiplication circuit to the first adder circuit when the AND gate is off. The circuit may further comprise a first bypass line directly connecting the first multiplication circuit and the first multiplexer to bypass the first adder circuit, wherein the first multiplexer has three inputs of the first bypass line, the first output form the first adder circuit, and a second bypass line directly connected to a second multiplication circuit.

For another example, at least one MAC accelerator 1031a-n may comprise a plurality of multiplication circuits configured to multiply the first set of inputs and the second set of inputs, an adder tree including, one or more levels of adder circuits to sum products from the plurality of multiplication circuits, a first bypass line directly connecting a first multiplication circuit of the plurality of multiplication circuit and a first multiplexer placed at an output of a first adder circuit. An AND gate is placed between the first multiplication circuit and the first adder circuit and configured to selectively transmit a multiplication output from the first multiplication circuit or a logic value of zero after an AND operation with zero to the first adder circuit. The first multiplexer configured to selectively transmit the first multiplication output from the first bypass line or a first output from the first adder circuit to a second adder circuit on a next level of the adder tree. The AND gate is turned on by a configuration signal when at least one input to the first multiplication circuit is zero or turned off by the configuration signal when no input to the first multiplication circuit is zero. The first multiplexer has three inputs of the first bypass line, the first output form the first adder circuit, and a second bypass line directly connected to a second multiplication circuit. The first multiplexer is configured by a configuration signal to output the first output from the first adder circuit when no input to the first multiplication circuit or the second multiplication circuit is zero. The first multiplexer is configured by the configuration signal to output from the first bypass line when at least one input to the second multiplication circuit is zero. The first adder circuit is bypassed without further processing. The circuit further comprises a plurality of bypass lines between different levels of the adder tree to selectively bypass one or more adder circuits on the different levels.

The data interface 1015 may comprise a communication interface, a user interface (such as a voice input interface, a graphical user interface, and/or the like). For example, the computing device 1000 may receive the input 1040 (such as a training dataset) from a networked database via a communication interface. Or the computing device 1000 may receive the input 1040, such as an input image, from a user via the user interface, and generate an output 1050 (such as 130 in FIG. 1).

Some examples of computing devices, such as computing device 1400 may include non-transitory, tangible, machine readable media that include executable code that when run by one or more processors (e.g., processor 1410) may cause the one or more processors to perform the processes of method. Some common forms of machine-readable media that may include the processes of method are, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, and/or any other medium from which a processor or computer is adapted to read.

Computing device 1000 may be comprised in a system for running one or more neural networks. The system comprises a splitter circuit splitting an input data value into an integer portion and a fractional portion, a compensation circuit generating a compensated fractional portion according at least a first output from a first comparator circuit comparing the fractional portion and a first threshold, a scheduler circuit dynamically determining a number of terms for approximating an exponential of the factional portion, and a Taylor expansion computation circuit computing a sum of the number of Taylor expansion terms for the compensated fractional portion.

FIGS. 9A-9B are example performance charts illustrating error and power efficiency of the exponential computation circuit described in FIGS. 1-8, according to one embodiment described herein. FIG. 9A shows the computation circuit shown in FIG. 3 may reduce at least 18% of compute energy with compensation circuit 310 (e.g., with legend “new dyn,” standard deviation of the tested random data “sign” = 1, 2, 4) compared to a scheme without compensation (e.g., with legend “dyn,” standard deviation of the tested random data “sign” = 1, 2, 4). FIG. 9B shows the computation circuit shown in FIG. 3 may achieve a 5.6 times reduction in error and 30% reduction in energy consumption with compensation circuit 310 (e.g., with legend “new dyn,” standard deviation of the tested random data “sign” = 1, 2, 4) compared to a scheme without compensation (e.g., with legend “dyn,” standard deviation of the tested random data “sign” = 1, 2, 4).

In one exemplary aspect, the present disclosure is directed to a circuit for performing computations of input data in a neural network. The circuit includes a splitter circuit splitting an input data value into an integer portion and a fractional portion, a compensation circuit generating a compensated fractional portion according at least a first output from a first comparator circuit comparing the fractional portion and a first threshold, a scheduler circuit dynamically determining a number of terms for approximating an exponential of the factional portion, and a Taylor expansion computation circuit computing a sum of the number of Taylor expansion terms for the compensated fractional portion. In some embodiments, the input data value comprises a first bit indicating a sign of the input data value, a first set of bits indicating an exponent of the input data value, and a second set of bits indicating a mantissa of the input data value. In some embodiments, the splitter circuit includes one or more shifter circuits that generate an unsigned integer portion and an unsigned fractional portion from the first set of bits and the second set of bits, a sign combiner circuit to generate the integer portion by combining the first bit with the unsigned integer portion, and a normalization circuit to generate the fractional circuit based on the first bit and the unsigned fractional portion. In some embodiments, the compensation circuit includes the first comparator circuit generating the first output comparing an absolute value of the fractional portion and a first threshold, a second comparator circuit generating a second output comparing at least a first bit of the input data value and zero, a first multiplexer selectively outputting a compensated integer portion from the integer portion, the integer portion plus one or minus one, according to a concatenation of the first output and the second output, and a second multiplexer selectively outputting a compensated fractional portion from the fractional portion, the fractional portion plus one or minus one, according to the concatenation of the first output and the second output. In some embodiments, the scheduler circuit includes one or more comparator circuits, each comparing the compensated fractional portion with a respective pre-defined thresholds thereby generating a respective comparison output indicating whether the compensated fractional portion is within a respective range, and a multiplexer selectively outputting one of a plurality of pre-defined quantities according to respective comparison outputs from the one or more comparator circuits. In some embodiments, the Taylor expansion computation circuit computes the sum of the number of Taylor expansion terms as an approximated exponential of the compensated fractional portion. In some embodiments, the circuit further includes a microcontroller retrieving from a lookup table in a memory unit an exponential of the compensated integer portion. In some embodiments, the circuit further includes a multiplier circuit outputting an exponential of the input data value as a multiplication of the exponential of the compensated integer portion and the approximated exponential of the compensated fractional portion. In some embodiments, the circuit further includes an artificial intelligence (AI) accelerator circuit comprising an arithmetic logic unit (ALU) computing a transformation of the input data value based on the exponential of the input data value when the input data value is part of an input to a neural network.

In another exemplary aspect, the present disclosure is directed to a method of operating an application-specific integrated circuit (ASIC) for performing computation of input data. The method includes splitting, by a splitter circuit, an input data value into an integer portion and a fractional portion, generating, by a compensation circuit, a compensated fractional portion according at least a first output from a first comparator circuit comparing the fractional portion and a first threshold, dynamically determining, by a scheduler circuit, a number of terms for approximating an exponential of the factional portion, computing, by a Taylor expansion computation circuit, a sum of the number of Taylor expansion terms for the compensated fractional portion as an approximated exponential of the compensated fractional portion, and outputting, by a multiplier circuit, an exponential of the input data value as a multiplication of an exponential of the compensated integer portion and the approximated exponential of the compensated fractional portion. In some embodiments, the input data value comprises a first bit indicating a sign of the input data value, a first set of bits indicating an exponent of the input data value, and a second set of bits indicating a mantissa of the input data value. In some embodiments, generating, by the compensation circuit, the compensated fractional portion includes generating, by the first comparator circuit, the first output comparing an absolute value of the fractional portion and a first threshold, generating, a second comparator circuit, a second output comparing at least a first bit of the input data value and zero, selectively outputting, by a first multiplexer, a compensated integer portion from the integer portion, the integer portion plus one or minus one, according to a concatenation of the first output and the second output, and selectively outputting, by a second multiplexer, a compensated fractional portion from the fractional portion, the fractional portion plus one or minus one, according to the concatenation of the first output and the second output. In some embodiments, dynamically determining, by the scheduler circuit, the number of terms includes comparing, by each of one or more comparator circuits, the compensated fractional portion with a respective pre-defined thresholds thereby generating a respective comparison output indicating whether the compensated fractional portion is within a respective range, and selectively outputting, by a multiplexer, one of a plurality of pre-defined quantities according to respective comparison outputs from the one or more comparator circuits. In some embodiments, the method further includes retrieving from a lookup table in a memory unit an exponential of the compensated integer portion. In some embodiments, the method further includes outputting, by a multiplier circuit, an exponential of the input data value as a multiplication of the exponential of the compensated integer portion and the approximated exponential of the compensated fractional portion.

In yet another exemplary aspect, the present disclosure is directed to a system running one or more neural networks. The system includes a splitter circuit splitting an input data value into an integer portion and a fractional portion, a compensation circuit generating a compensated fractional portion according at least a first output from a first comparator circuit comparing the fractional portion and a first threshold, a scheduler circuit dynamically determining a number of terms for approximating an exponential of the factional portion, and a Taylor expansion computation circuit computing a sum of the number of Taylor expansion terms for the compensated fractional portion. In some embodiments, the compensation circuit includes the first comparator circuit generating the first output comparing an absolute value of the fractional portion and a first threshold, a second comparator circuit generating a second output comparing at least a first bit of the input data value and zero, a first multiplexer selectively outputting a compensated integer portion from the integer portion, the integer portion plus one or minus one, according to a concatenation of the first output and the second output, and a second multiplexer selectively outputting a compensated fractional portion from the fractional portion, the fractional portion plus one or minus one, according to the concatenation of the first output and the second output. In some embodiments, the scheduler circuit includes one or more comparator circuits, each comparing the compensated fractional portion with a respective pre-defined thresholds thereby generating a respective comparison output indicating whether the compensated fractional portion is within a respective range, and a multiplexer selectively outputting one of a plurality of pre-defined quantities according to respective comparison outputs from the one or more comparator circuits. In some embodiments, the Taylor expansion computation circuit computes the sum of the number of Taylor expansion terms as an approximated exponential of the compensated fractional portion. The system further includes a microcontroller retrieving from a lookup table in a memory unit an exponential of the compensated integer portion. In some embodiments, the system further includes a multiplier circuit outputting an exponential of the input data value as a multiplication of the compensated integer portion and the approximated exponential of the compensated fractional portion.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. A circuit for performing a multiply-accumulation operation on a first set of inputs and a second set of inputs, comprising:
a plurality of multiplication circuits configured to multiply the first set of inputs and the second set of inputs;
an adder tree including:
one or more levels of adder circuits to sum products from the plurality of multiplication circuits;
a first output register and a first multiplexer placed between a first adder circuit and a second adder circuit on a next level o the adder tree;
the first output register configured to store a first output from the first adder circuit;
the first multiplexer configured to selectively transmit the first output from the first adder circuit or a logic value of zero to the second adder circuit.

2. The circuit of claim 1, wherein the first multiplexer is configured to transmit the first output from the first adder circuit to the second adder circuit when a configuration signal is configured at a first logic value, and the second adder circuit is configured to add the first output and a second output from another adder circuit at a same level with the first adder circuit in the adder tree.

3. The circuit of claim 1, wherein the first multiplexer is configured to transmit the logic value of zero to the second adder circuit when a configuration signal is configured at a second logic value, and wherein a final output of the adder tree is sampled from the first output register.

4. The circuit of claim 3, wherein the second adder circuit is refrained from further processing when the final output of the adder tree is sampled from the first output register.

5. The circuit of claim 1, further comprising:
at least a second multiplexer, placed between one multiplication circuit of the plurality of multiplication circuits and a first level adder circuit in the one or more levels adder circuits, configured to selectively transmit a multiplication output from the one multiplication circuit or a logic value of zero to the first level adder circuit.

6. The circuit of claim 1, wherein the adder tree further comprises:
a respective output register connected to a respective output at each level of adder circuit; and
a respective multiplexer placed between each level of adder circuit and a respective next level of adder circuit.

7. The circuit of claim 1, wherein multiple output registers are placed at every other adder circuit at each level of adder circuit for output sampling.

8. The circuit of claim 1, further comprising:
an AND gate, placed between a first multiplication circuit and a first adder circuit, configured to selectively transmit a logic value of zero after an AND operation with zero to the first adder circuit when the AND gate is on, or a multiplication output from the multiplication circuit to the first adder circuit when the AND gate is off.

9. The circuit of claim 8, further comprising:
a first bypass line directly connecting the first multiplication circuit and the first multiplexer to bypass the first adder circuit
wherein the first multiplexer has three inputs of the first bypass line, the first output form the first adder circuit, and a second bypass line directly connected to a second multiplication circuit.

10. A circuit for performing a multiply-accumulation operation on a first set of inputs and a second set of inputs, comprising:
a plurality of multiplication circuits configured to multiply the first set of inputs and the second set of inputs;
an adder tree including:
one or more levels of adder circuits to sum products from the plurality of multiplication circuits;
a first bypass line directly connecting a first multiplication circuit of the plurality of multiplication circuit and a first multiplexer placed at an output of a first adder circuit,
wherein an AND gate is placed between the first multiplication circuit and the first adder circuit and configured to selectively transmit a multiplication output from the first multiplication circuit or a logic value of zero after an AND operation with zero to the first adder circuit;
the first multiplexer configured to selectively transmit the first multiplication output from the first bypass line or a first output from the first adder circuit to a second adder circuit on a next level of the adder tree.

11. The circuit of claim 10, wherein the AND gate is turned on by a configuration signal when at least one input to the first multiplication circuit is zero, or turned off by the configuration signal when no input to the first multiplication circuit is zero.

12. The circuit of claim 10, wherein the first multiplexer has three inputs of the first bypass line, the first output form the first adder circuit, and a second bypass line directly connected to a second multiplication circuit.

13. The circuit of claim 12, wherein the first multiplexer is configured by a configuration signal to output the first output from the first adder circuit when no input to the first multiplication circuit or the second multiplication circuit is zero.

14. The circuit of claim 12, wherein the first multiplexer is configured by the configuration signal to output from the first bypass line when at least one input to the second multiplication circuit is zero.

15. The circuit of claim 14, wherein the first adder circuit is bypassed without further processing.

16. The circuit of claim 10, further comprising:
a plurality of bypass lines between different levels of the adder tree to selectively bypass one or more adder circuits on the different levels.

17. A method of performing a multiply-accumulation operation on a first set of inputs and a second set of inputs at a multiply-accumulation accelerator, comprising:
performing multiplication between the first set of inputs and the second set of inputs via
a plurality of multiplication circuits;
summing products from the plurality of multiplication circuits at an adder tree including one or more levels of adder circuits, including:
selectively transmitting, by a first multiplexer placed between a first adder circuit and a second adder circuit on a next level to the adder tree, a first output from the first adder circuit or a logic value of zero to the second adder circuit; and
sampling, from a first output register storing the first output, an output of the adder tree when the first multiplexer outputs the logic value of zero.

18. The method of claim 17, further comprising:
determining, by a processor, that a size of the first set or the second set of inputs is smaller than a number of the plurality of the multiplication circuits;
configuring a multiplexer selection signal at a first logic value for the first multiplexer thereby causing the first multiplexer to output the logic value of zero.

19. The method of claim 18, further comprising:
refraining from further summing data at the second adder circuit or any higher level adder circuit.

20. The method of claim 17, further comprising:
determining, by a processor, whether that at least one input to the plurality of multiplication circuits is zero;
configuring an AND configuration signal at a first logic value to enable an AND gate placed between a first multiplication circuit and the first adder circuit;
passing, by the AND gate, a logic value of zero after an AND operation with zero to the first adder circuit.
